(19) United States
(12) Patent Application Publication
(10) Pub. No.: US 2008/0172562 A1
(43) Pub. Date: Jul. 17, 2008

(54) ENCRYPTION AND AUTHENTICATION OF DATA AND FOR DECRYPTION AND VERIFICATION OF AUTHENTICITY OF DATA

(76) Inventors: Christian Cachin, Thalwil (CH); Paul T. Hurley, Zurich (CH); Roman A. Pletka, Horgen (CH)

Correspondence Address: Ido Tuchman, 82-70 Beverly Road, Kew Gardens, NY, 11415, US

(21) Appl. No.: 11/622,467

(22) Filed: Jan. 12, 2007

(51) Int. Cl. G06F 12/14

(52) U.S. Cl. 713/193

(57) ABSTRACT

Techniques for encryption and authentication of data. One or more plaintext data blocks ciphertext data blocks and corresponding authentication tags are generated by means of authenticated encryption. A tag tree is generated by means of the authentication tags. The ciphertext data blocks and the tag tree data of the tag tree are stored in an untrusted storage, and the root tag of the tag tree is stored in a trusted storage.

### BACKGROUND OF THE INVENTION

The present invention relates to a method for encryption and authentication of data, a method for decryption and verification of authenticity of data, a method for generating a tag authentication tree, and a method for decryption and verification of authenticity of encrypted authentication tags of a tag tree. These methods may be used for example in storage media which store data block by block.

A filesystem organizes data into a set of files and a hierarchy of directories for storage on a storage device which can be a hard disk or another storage media. Because the storage space of storage devices is typically structured in blocks, the directories are stored together with the files block by block on the storage device. The storage medium may be exposed to unauthorized access by a third party, and in this case the confidentiality and/or the integrity or authenticity of the stored data may be violated. In order to protect data against such violations, cryptographic filesystems employ encryption and cryptographic authentication based on public-key signatures, message authentication codes, or hashing. With that, the problem of maintaining confidentiality and integrity of the stored data can be reduced to maintaining confidentiality and integrity of the corresponding encryption keys and authentication values.

A cryptographic filesystem called CFS is described in M. Blaze, “A cryptographic file system for Unix,” in Proc. 1st ACM Conference on Communications and Computing Security, 1993, and protects confidentiality by encrypting the data, using a block cipher, before storing it on the disk. For encrypting a long stream of data, the block cipher uses a chaining mode, such as Cipher Block Chaining Mode, called CBC mode, or Output Feedback Mode, called OFB mode, which are described in A. J. Menezes, P. C. van Oorschot, and S. A. Vanstone, Handbook of Applied Cryptography. Boca Raton, Fla.: CRC Press, 1997, for concatenating encryption blocks, to avoid that information about plaintext data may be apparent from the ciphertext. By design, such a stream can only be read and written sequentially from start to end. Because a file system requires random access to an encrypted file, the cryptographic filesystem should not encrypt the whole file in one unit, but only one storage block at a time. Since the block size of the cipher typically is 8 or 16 bytes, it is much smaller than the storage device block size, which is typically 512 or 4096 bytes. Therefore, this still requires a chaining mode.

To protect confidentiality and integrity in a cryptographic filesystem a hash tree for that purpose can be used. Hash trees are proposed by Merkle in the U.S. Pat. No. 4,309,569 for authenticating data. The (encrypted) data on the disk blocks is hashed and the resulting hash values are assigned to the leaves in the hash tree. This means that the stored data is encrypted and hashed. The hash tree is computed on the encrypted data, i.e., the ciphertext, obtained with a block-cipher chaining mode. In this way, confidentiality and integrity protection are orthogonal to each other, and, therefore, a client with read access to a file cannot modify its contents. On the other hand, this is costly and time consuming because it involves for reading and writing two passes over every storage block: one for encryption using the block-cipher chaining mode and one for computing the hash value.

### BRIEF SUMMARY OF THE INVENTION

Embodiments of the invention are a method for encryption and authentication of data, a method for decryption and verification of authenticity of data, a method for generating a tag authentication tree, and a method for decryption and verification of authenticity of encrypted tags of a tag tree, which are efficient, time saving and easy to implement.

One exemplary aspect of the invention is a method for encryption and authentication of data according to the invention comprises the following steps. In a first step from one or more plaintext data blocks, ciphertext data blocks and corresponding authentication tags are generated by means of authenticated encryption. In a further step a tag tree is generated by means of the authentication tags.

A further exemplary aspect of the invention is a method for decryption and verification of authenticity of data according to the invention comprises the following steps. In a first step from one or more ciphertext data blocks and corresponding authentication tags from a tag tree, plaintext data blocks and verification values are generated by means of authenticated decryption. In a further step the authentication tags are verified by means of a root tag, and the plaintext data blocks are outputted, if the verification values and the verification of the authentication tags confirm the authenticity of the data and the authentication tags.

Yet another exemplary aspect of the invention is a method for generating a tag authentication tree according to the invention comprises the following steps. In a first step from plaintext data blocks authentication tags are generated by means of authenticated encryption. In a further step the authentication tags are concatenated to concatenated authentication tags. From the concatenated authentication tags encrypted authentication tags and authentication tags for authentication of the encrypted authentication tags are generated by means of authenticated encryption.

Another exemplary aspect of the invention is a method for decryption and verification of authenticity of encrypted authentication tags of a tag tree according to the invention comprises the following steps. In a first step from the encrypted authentication tags and a parent authentication tag, decrypted authentication tags and a tag verification value are generated means of authenticated decryption. In a further step from one or more ciphertext data blocks plaintext data blocks and comparison tags are generated by means of authenticated decryption. The plaintext data blocks are output, if the tag verification values and the verification of the comparison tags confirm the authenticity of the data and the authentication tags.

Preferably, in the method for encryption and authentication according to the invention, the tag tree comprises tag tree data and data representing a root authentication tag, wherein the tag tree data are stored in an untrusted storage, and the data representing the root authentication tag is stored in a trusted storage.

In an embodiment of the method for encryption and authentication according to the invention, the ciphertext data blocks are stored in the untrusted storage.

In a further embodiment of the method for encryption and authentication according to the invention the authenticated encryption is performed by AES (advanced encryption standard) in IAPM (Integrity Aware parallelizable Mode), OCB (Offset Codebook Mode), or GCM (Galois/Counter Mode) mode of operation. One of these operating modes can also be used for authenticated decryption for example in the method for decryption and verification of authenticity of data.

In an embodiment of the method for generating a tag authentication tree according to the invention the encrypted authentication tags are stored in an untrusted storage, and the last generated authentication tag is stored in a trusted storage.

In an embodiment of the method for decryption and verification of authenticity of encrypted authentication tags of a tag tree according to the invention the verification of one of the comparison tags involves the comparison of the comparison tag with the corresponding decrypted authentication tag.

Finally, in these methods according to the invention the untrusted and/or trusted storage can be preferably a storage which is structured in blocks.

Furthermore, a computer program element can be provided, comprising computer program code for performing steps according to one of the above mentioned methods when loaded in a digital processor of a computing device.

Additionally, a computer program product stored on a computer usable medium can be provided, comprising computer readable program code for causing a computing device to perform one of the mentioned methods.

### BRIEF DESCRIPTION OF THE SEVERAL VIEWS OF THE DRAWINGS

FIG. 1 shows a flow diagram of a method for encryption and authentication of data according to the invention.

FIG. 2 shows a tag tree according to the invention.

FIG. 3 shows a flow diagram of a method for decryption and verification of authenticity of data according to the invention.

FIG. 4 shows a first part of a flow diagram of a method for generating leave nodes and internal nodes of a tag authentication tree using authenticated encryption according to the invention.

FIG. 5 shows a second part of the flow diagram of the method generating the root node of the tag authentication tree.

FIG. 6 shows a flow diagram of a method for decryption and verification of authenticity of tags of the tag authentication tree according to the invention.

### DETAILED DESCRIPTION OF THE INVENTION

In the following, a description will be provided of the present invention through an embodiment of the present invention. However, the following embodiments do not restrict the invention in the scope of the invention and all combinations of features explained in the embodiment are not always essential to means of the invention for solving the problems.

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

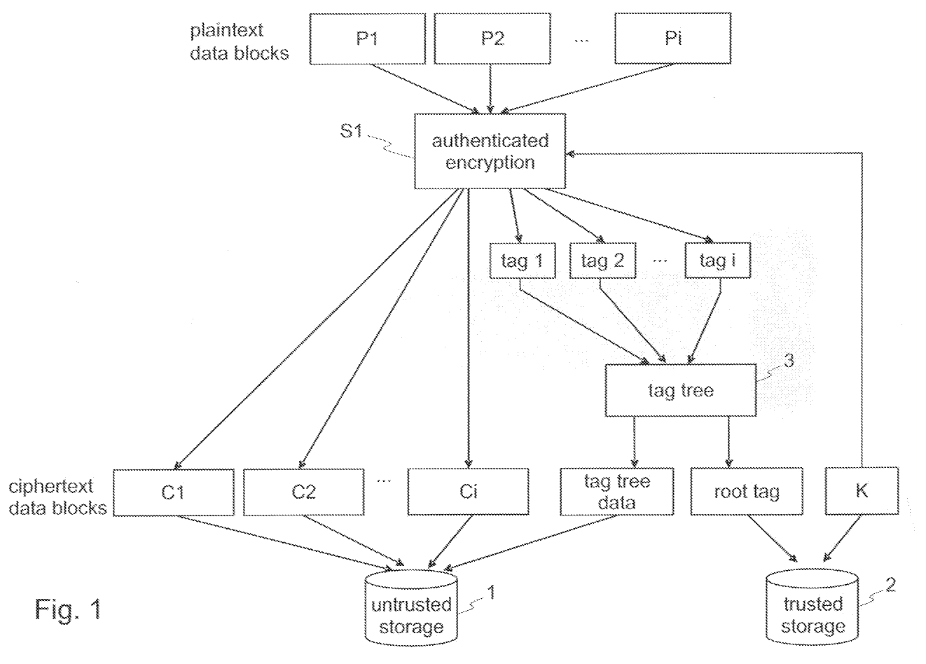

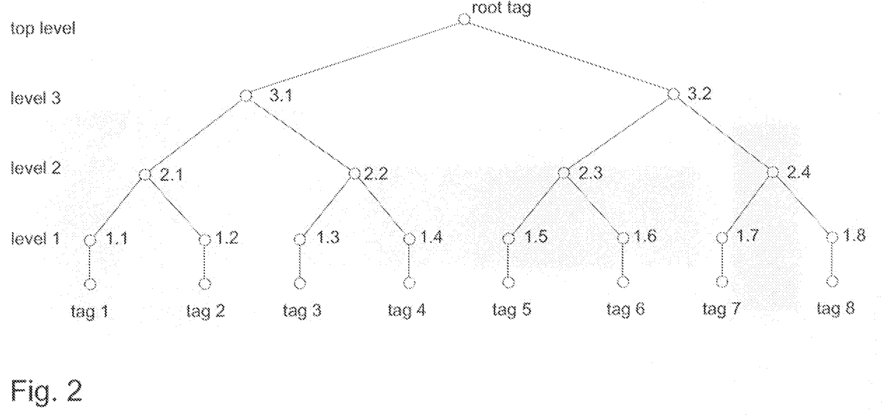

To keep the explanation of the methods according to the invention simple the flow diagrams of the FIG. 1, and 3 to 6 show simple and short examples. The invention however is not restricted to this examples, and particularly not to a tag tree having eight tags as depicted in FIG. 2. The methods according to the invention can be applied for tag trees with arbitrary number of nodes or tags and arbitrary number of child nodes for a parent node.

The flow diagram in FIG. 1 depicts an embodiment of a method for data encryption and data authentication according to the invention. Furthermore, the flow diagram shows how data is processed for ensuring the confidentiality and integrity of the data when storing the data on an untrusted storage device. The confidentiality of the data is achieved by data encryption and the protection of the data integrity is achieved by data authentication.

Plaintext data blocks can be for example text data, image data, music data, or any other data in unencrypted or previously encrypted form. Previously encrypted plaintext is encrypted by means that are not related to the methods according to the invention. Therefore, the methods according to the invention have no knowledge about a previous encryption and the encryption status. Hence, this data is treated as being unencrypted. For example, data which has been previously encrypted is handled by the methods according to the invention as plaintext. Cipher text data blocks are data blocks in an encrypted form derived from plain text data blocks. The cipher text data blocks are stored block by block on a storage, for example a hard disk.

Multiple plaintext, i.e. unencrypted data blocks P1, P2 to Pi, are processed by the authenticated encryption process S1. The authenticated encryption process S1 uses a block cipher for encryption, such as AES, in a mode of operation, such as IAPM, OCB, or GCM that provides also data authentication. Further information on the Advanced Encryption Standard (AES) can be found in National Institute of Standards and Technology (NIST), “Advanced Encryption Standard (AES)”, Federal Information Processing Standards (FIPS), Publication 197, November 2001. Further information on integrity aware parallelizable mode (IAPM) can be found in C. Jutla, “Symmetric key authenticated encryption schemes”, U.S. Pat. No. 6,963,976. Additional information on Offset Codebook Mode (OCB) can be found on the web page http://www.cs.ucdavis.edu/˜rogaway/ocb/, and in P. Rogaway, “Method and apparatus for facilitating efficient authenticated encryption”, U.S. Patent Publication No. 2002/0071552A1. Further information on GCM can be found in McGrew, D. and J. Viega, “The Galois/Counter Mode of Operation (GCM)”, Submission to NIST, and on the web page http://csrc.nist.gov/CryptoToolkit/modes/proposedmodes/gcm/gcm-spec.pdf, January 2004. The authenticated encryption process S1 takes as input for example the plaintext data block P1 and a (short) secret key K and outputs a ciphertext, i.e. an encrypted data block C1, and a (short) authentication tag 1. The resulting ciphertext data block C1 is usually of the same length as the plaintext data block P1. The authenticated encryption S1 with the same key K is applied to the remaining plaintext data blocks P2 to Pi, and produces for each plaintext data block P2 to Pi a corresponding ciphertext data block C2 to Ci and an authentication tag 2 to tag i. In doing so, it is not necessary to encrypt and authenticate the plaintext data blocks P1 to Pi in a particular order. The ciphertext data blocks C1 to Ci are stored on an untrusted storage 1.

The authentication tags 1 to i are the inputs to a tag tree 3, which is also called tag authentication tree. An example of a tag tree 3 is depicted in FIG. 2. The tag tree 3 is constructed in the same way as a Merkle tree from the tags as input values. A Merkle tree is a k-ary tree with an assignment of a string to each node such that the values of parent's node are one-way functions of the children's node values. The parent node of a set of direct child nodes can be evaluated by applying a message authentication code or hash method as soon as all tag values of the direct child nodes are available. Similarly, k parent nodes are the child nodes for the next level parent node and can be evaluated as soon as they are available. The last parent node which is the highest node in the tree is the root tag value and is stored on a trusted storage device. Further information about the construction of a Merkle tree can be found in the U.S. Pat. No. 4,309,569. The construction of the Merkle tree can involve the use of a collision-free hash function (“collision-free” is a security requirement on the hash function). The tag tree construction outputs tag tree data and a root tag value. The tag tree data may be stored on the untrusted storage, but the root tag value is stored on the trusted storage. The goal of this process is to derive, at a later stage, the integrity of the data blocks from the confidentiality of the key and the integrity of the root tag value. This can be ensured, for example, by only storing the key and the root tag value in trusted storage space.

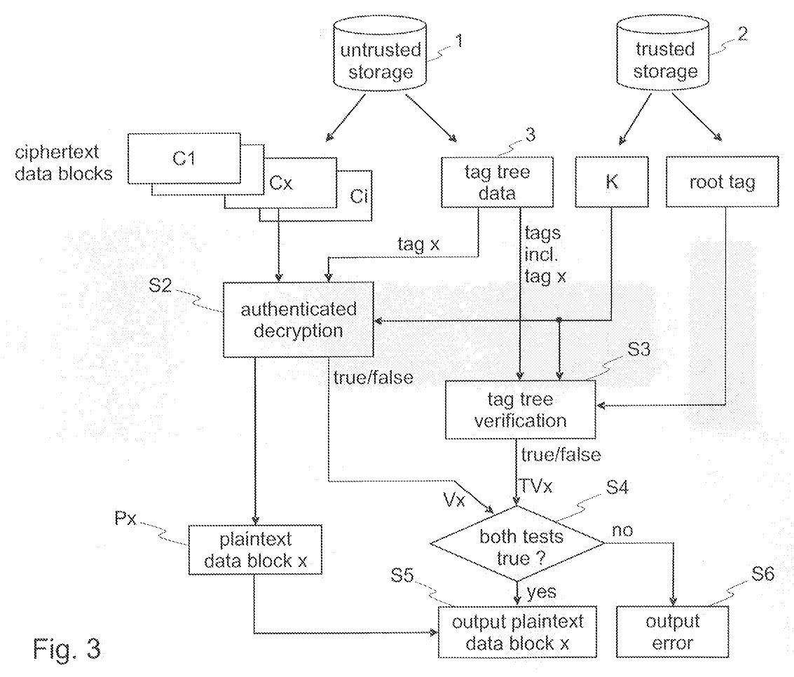

The flow diagram in FIG. 3 depicts an embodiment of a method for data decryption and data verification according to the invention. Particularly, the flow in FIG. 3 shows how data, which is stored on the untrusted storage space 1, and to which integrity and confidentiality protection had been applied earlier as is described in FIG. 1, is processed for decryption and verification of data authenticity.

The ciphertext data blocks C1 to Ci are processed by the authenticated decryption process as shown in FIG. 3. The authenticated decryption process is the reverse operation of the authenticated encryption process of FIG. 1. It takes as input one of the ciphertext data blocks C1 . . . Ci, a (short) secret key K, and the corresponding authentication tag, and outputs a plaintext data block P1 . . . Pi and a binary verification value V1 . . . Vi, which can be either true or false. The verification value V1 . . . Vi indicates whether the integrity of the output plaintext data block has been preserved or whether the ciphertext data block C1 . . . Ci or the corresponding authentication tag has been modified since the time of applying the integrity protection through the authenticated encryption process. First, in the authenticated decryption process for example the ciphertext data block Cx is read from the untrusted storage 1, the secret key K and the corresponding authentication tag x is read from the trusted storage 2. Then, the authenticated decryption process S2 is applied on it and the plaintext data block Px and the binary verification value Vx are outputted. The authenticated decryption process S2 is applied to the remaining ciphertext data blocks C1 to Ci, and produces for each ciphertext block C1 to Ci a plaintext block P1 to Pi and a verification value V1 to Vi. In doing so, it is not necessary to execute the decryption and Verification of the ciphertext data block C1 to Ci in a particular order.

The tag tree data 3, the root tag value and the secret key K serve as inputs to the verification process S3 of the tag authentication tree 3. Therefore, the tag tree data 3 are read from the untrusted storage 1, and the root tag value is read from the trusted storage 2. In case the tag tree data 3 are encrypted the secret key K is stored on the trusted storage 2 and read from there.

In the following, the flow diagram of FIG. 3 is further explained by means of an example. The verification of the tag x, which has been read from the untrusted storage 1, in step S3 is carried out thereby that the root tag value is calculated again under consideration of the tag x and other relevant tags of the tag tree 3. The verification of the tag x with respect to the root tag value, in the tag authentication tree verification, can be done in the same way as the verification of a leaf node with respect to the root hash value in the Merkle tree, described in U.S. Pat. No. 4,309,569. A Boolean tag verification value TVx is set to true, if the verification S3 of the tag x and the tag tree respectively was successful, i.e. if the tag x has been authenticated.

If both, the verification value Vx from the authenticated decryption process S2 of the corresponding ciphertext data block Cx and the tag verification value TVx from the verification S3 of the tag tree, are true (step S4), the plaintext data block Px is returned as the output (step S5). Otherwise, it is assumed that the integrity of the decrypted ciphertext data block Cx has been violated and an error is returned (S6).

The tag tree verification S3 is applied to the remaining tags 1 to i, and produces for each verified tag 1 to i a corresponding Boolean tag verification value TV1 to TVi. Each time when the tag verification value TV and the verification value V are true, the corresponding plain text data block is returned.

The authenticated decryption process S2 can use for example AES in one of the above mentioned operation modes such as IAPM, OCB, or GCM for data decryption and also for data authentication. In principle AES in IAPM, OCB, and GCM mode can be used for authenticated encryption and also for authenticated decryption.

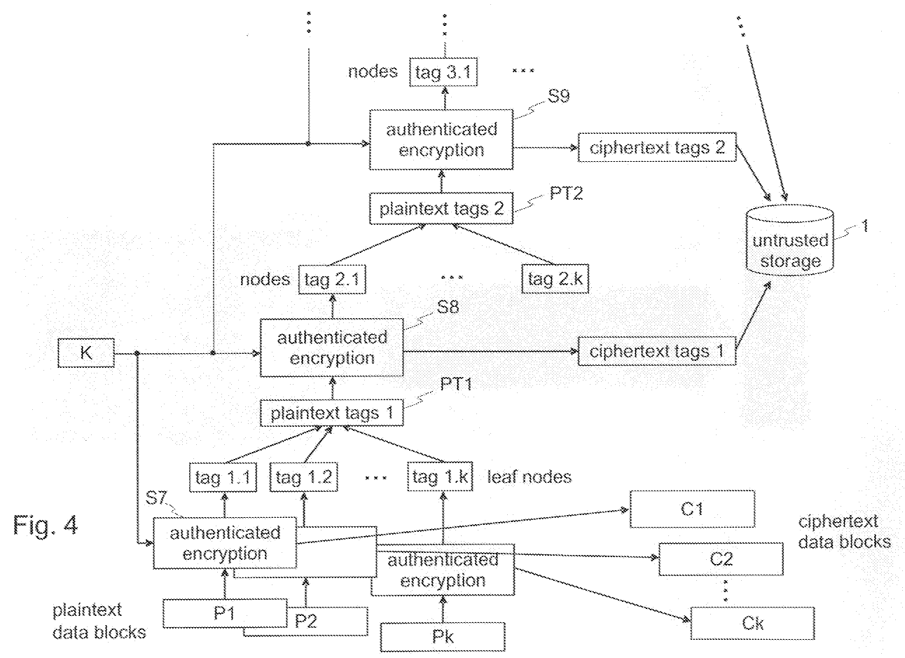

The flow diagram in FIG. 4 demonstrates how a tag authentication tree is implemented using authenticated encryption. In the tag authentication tree, every node is represented by a tag value.

The lower part of FIG. 4 shows the derivation of a leaf node of the tag authentication tree which is utilized for the construction of the tag authentication tree. The tag value of a leaf node is derived from the authenticated encryption of a plaintext data block. For example, the authenticated encryption S7 encrypts the plaintext data block P1 and generates thereof a ciphertext data block C1 and an authentication tag 1.1 as already mentioned above under FIG. 1. The ciphertext data block C1 is stored in the untrusted storage 1. The authentication tag 1.1 is used as the tag value of a leaf node in the authentication tree. The remaining leaf nodes comprising the tags 1.2 to 1.i of the authentication tree are constructed in the same way.

The upper part of FIG. 4 exemplifies the derivation of two internal nodes of the tag authentication tree 4. The tag values tag 1.1 . . . tag 1.k representing some of the leaf nodes are concatenated together to plaintext tags 1, indicated in FIG. 4 with reference sign PT1, and processed through an authenticated encrypted process S8. The authenticated encrypted process S8 uses the secret key K as input to encrypt the plaintext tags 1 (PT1). The authenticated encryption S8 outputs ciphertext tags 1, which contain the encrypted tag values tag 1.1 . . . tag 1.k from the children nodes, and an authentication tag 2.1. The ciphertext tags 1 are stored in the untrusted storage 1. The authentication tag 2.1 is concatenated with further authentication tags 2.2 to 2.k to plaintext tags 2, which are input to the authenticated encryption S8 of the parent node. The authenticated encryption S8 outputs ciphertext tags 2, which contain the encrypted tag values tag 2.1 . . . tag 2.k. Furthermore, the authenticated encryption S9 outputs an authentication tag 3.1.

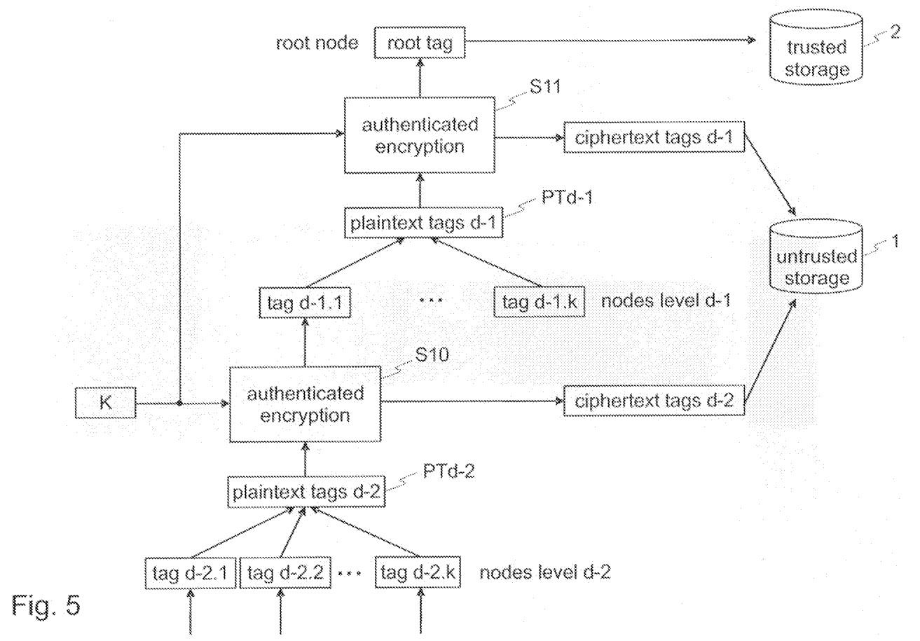

The flow diagram in FIG. 5 demonstrates how the root tag value of a tag authentication tree is can be derived using authenticated encryption. The tag values tag d-2.1 to tag d-2.k represent the children nodes or nodes of the third highest level. They are concatenated together to plaintext tags d-2, indicated in FIG. 5 with reference sign PTd-2, and processed through an authenticated encrypted process S10. The authenticated encrypted process S10 uses the secret key K to encrypt the plaintext tags d-2 (PTd-2). The authenticated encryption S10 outputs ciphertext tags d-2, which contain the encrypted tag values tag d-2.1 . . . tag d-2.k, and an authentication tag d-1.1. The ciphertext tags d-2 are stored in the untrusted storage 1. The authentication tag d-1.1 is concatenated with further authentication tags d-1.2 to d-1.k of the same level to plaintext tags d-1 (PTd-1), which are input to the authenticated encryption process S11 of the parent node. The authenticated encryption S11 outputs ciphertext tags d-1, which contain the encrypted tag values tag d-1.1 to tag d-1.k. Furthermore, the authenticated encryption S11 outputs an authentication tag called root tag, which represents the root node or highest node in the tag authentication tree.

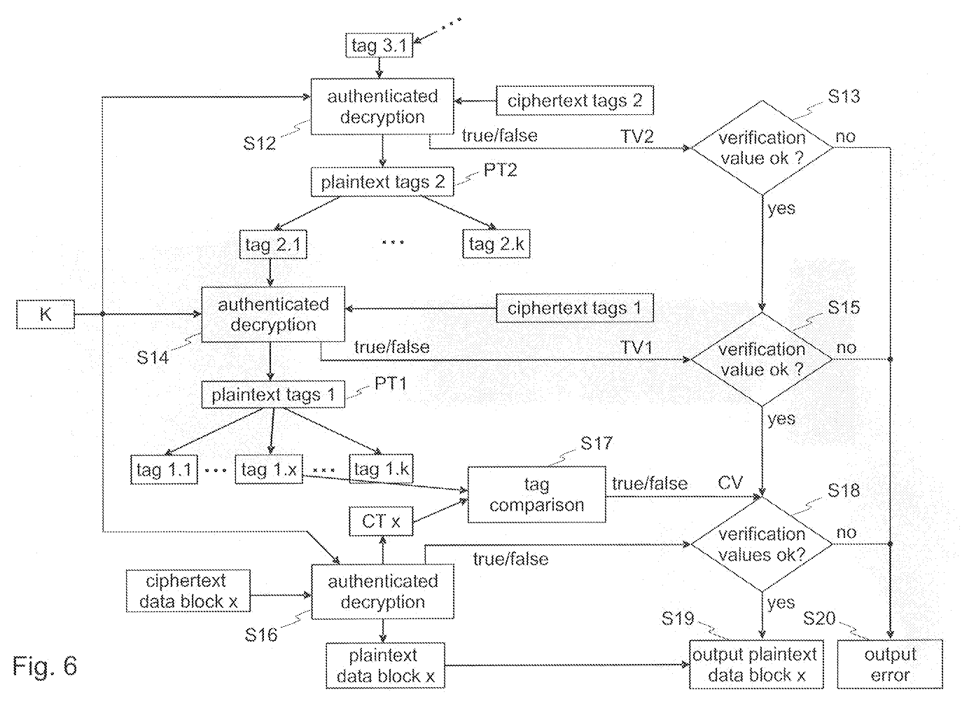

In the following a method for decryption and verification of authenticity of tags of the tag authentication tree according to FIG. 4 and 5 is explained. Therefore, the flow diagram in FIG. 6 demonstrates how a tag authentication tree using authenticated decryption is processed for decryption and verification of authenticity of data blocks. As depicted in FIG. 6 in step S18 the authenticated decryption takes the key K, the ciphertext tags 2, and the tag 3.1, which is in this case the parent node, as input and generates the plaintext tags 2 and a Boolean tag verification value TV2 as output. In case of an incorrect tag verification value TV2 an output error is returned immediately (step S20). Otherwise, the tag verification value TV2 is classified as correct and the verification process is continued. The plaintext tags 2 are split into tags 2.1 to 2.k, which serve as input for the next authenticated decryption process S14. The authenticated decryption S14 takes the key K, the ciphertext tags 1, and the tag 2.1, which is in this case the parent node, as input and generates the plaintext tags 1 (PT1) and a Boolean tag verification value TV1 as output. In step S15 it is checked whether the tag verification value TV1 is correct. If the tag verification value TV1 is incorrect, i.e. the verification of tag 2.1 failed, an output error is returned immediately (step S20). Otherwise, the tag verification value TV2 is classified as correct and the verification process is continued.

If the last authenticated decryption step S16 of the tag authentication tree is correct, a given authentication tag 1.x is compared to a candidate tag CTx, which has been obtained from the authenticated decryption process S16 of the corresponding ciphertext data block x. The comparison S17 results in a comparison verification value CV. If both, the tag verification value TV1 of the authenticated decryption S14 of the ciphertext tags 1 and the comparison verification value CV are correct, then the corresponding plaintext data block is returned in step S19. Otherwise an output error is returned (step S20).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

That which is claimed is:

1. Method for encryption and authentication of data, comprising:
generating from one or more plaintext data blocks ciphertext data blocks and corresponding authentication tags by means of authenticated encryption; and
generating a tag tree by means of the authentication tags.

2. A method according to claim 1,
wherein the tag tree comprises tag tree data and data representing a root authentication tag;
wherein the tag tree data are stored in an untrusted storage; and
wherein the data representing the root authentication tag is stored in a trusted storage.

3. A method according to claim 2, wherein the ciphertext data blocks are stored in the untrusted storage.

4. A method according to claim 1, wherein the authenticated encryption is performed by AES using IAPM, OCB, or GCM.

5. A method for decryption and verification of authenticity of data, the method comprising:
generating from one or more ciphertext data blocks and corresponding authentication tags from a tag tree plaintext data blocks and verification values by means of authenticated decryption;
verifying the authentication tags by means of a root tag; and
outputting the plaintext data blocks, if the verification values and the verification of the authentication tags confirm the authenticity of the data and the authentication tags.

6. A method according to claim 5, wherein the authenticated decryption is performed by AES, IAPM, OCB, or GCM.

7. A method for generating a tag authentication tree, the method comprising:
generating from plaintext data blocks authentication tags by means of authenticated encryption;
concatenating the authentication tags to concatenated authentication tags; and
generating from the concatenated authentication tags encrypted authentication tags and authentication tags by means of authenticated encryption.

8. A method according to claim 7,
wherein the encrypted authentication tags are stored in an untrusted storage; and
wherein the last generated authentication tag is stored in a trusted storage.

9. A method for decryption and verification of authenticity of encrypted authentication tags of a tag tree comprising:
generating from the encrypted authentication tags and a parent authentication tags decrypted authentication tags and tag verification values by means of authenticated decryption;
generating from one or more ciphertext data blocks plaintext data blocks and comparison tags by means of authenticated decryption; and
outputting the plaintext data blocks, if the tag verification values and the verification of the comparison tags confirm the authenticity of the data and the decrypted authentication tags.

10. A method according to claim 9, wherein the verification of one of the comparison tags includes comparing the comparison tag with the corresponding decrypted authentication tag.

11. The method according to claim 9 further comprising using a storage which is structured in blocks as untrusted and/or trusted storage.

12. A computer program product embodied in a tangible media comprising:
computer readable program codes coupled to the tangible media for encryption and authentication of data, the computer readable program codes configured to cause the program to:
generate from one or more plaintext data blocks ciphertext data blocks and corresponding authentication tags by means of authenticated encryption; and
generate a tag tree by means of the authentication tags.

13. An apparatus for encryption and authentication of data, the apparatus comprising:
a generator for:
generating from one or more plaintext data blocks ciphertext data blocks and corresponding authentication tags by means of authenticated encryption; and
generating a tag tree by means of the authentication tags.
